(19) United States
(12) Patent Application Publication
(10) Pub. No.: US 2017/0163852 A1
(43) Pub. Date: Jun. 8, 2017

(54) METHOD AND ELECTRONIC DEVICE FOR DYNAMICALLY ADJUSTING GAMMA PARAMETER

(71) Applicants: LE HOLDINGS (BEIJING) CO., LTD., Beijing (CN); LEMOBILE INFORMATION TECHNOLOGY (BEIJING) CO., LTD., Beijing (CN)

(72) Inventors: Zhenhua Li, Beijing (CN); Cong Gao, Beijing (CN)

(21) Appl. No.: 15/243,181

(22) Filed: Aug. 22, 2016

Related U.S. Application Data
(63) Continuation of application No. PCT/CN2016/088961, filed on Jul. 6, 2016.

(30) Foreign Application Priority Data
Dec. 8, 2015 (CN) 201510896559.1

(51) Int. Cl. H04N 5/202; H04N 9/73; H04N 9/04; H04N 5/232

(52) U.S. Cl. CPC H04N 5/202; H04N 5/23293; H04N 9/735; H04N 9/045

(57) ABSTRACT

Disclosed are a method and a device for dynamically adjusting gamma parameter. The method comprises: acquiring a preview image; abstracting at least one parameter data of automatic exposure data, automatic white balance data and scene data of the preview image; adjusting the gamma parameter value according to the at least one parameter data of the automatic exposure data, the automatic white balance data and the scene data; and adjusting the current preview image according to the gamma parameter value.

### CROSS-REFERENCE TO RELATED APPLICATIONS

This application is a continuation of International Application No. PCT/CN2016/088961 filed on Jul. 6, 2016, which is based upon and claims priority to Chinese Patent Application No. 201510896559.1 filed on Dec. 8, 2015, titled “METHOD AND DEVICE FOR DYNAMICALLY ADJUSTING GAMMA PARAMETER”, the entire contents of all of which are incorporated herein by reference.

### TECHNICAL FIELD

This disclosure relates to the field of image processing technologies, and in particular, to a method and an electronic device for dynamically adjusting gamma parameter.

### BACKGROUND

Gamma parameter value can reflect the sense of light of human eyes, and it may be used for adjusting the parameters of an image such as brightness, contrast and saturation, etc. The sensitization of an image sensor of a camera in an intelligent apparatus is linear, that is, a fixed Gamma parameter value is employed in different scenes. However, the sensitization of human eyes is nonlinear. As a result, a photo or a video of a camera differs greatly from what human eyes see. Moreover, when the same Gamma parameter value is employed in different scenes, it will cause problems, such as mist in fine days and low brightness at night, to a photo or video viewed by human eyes.

### SUMMARY

The disclosure provides a method and an electronic device for dynamically adjusting gamma parameter, thereby effectively recovering the nature of a scene and improving the image quality.

In one aspect, the disclosure provides a method for dynamically adjusting gamma parameter, which includes:

acquiring a preview image;

abstracting at least one parameter data of automatic exposure data, automatic white balance data and scene data of the preview image;

adjusting the gamma parameter value according to the at least one parameter data of the automatic exposure data, the automatic white balance data and the scene data; and

adjusting the current preview image according to the gamma parameter value.

In another aspect, this disclosure further provides an electronic device for dynamically adjusting gamma parameter, which includes:

at least one processor; and

a memory communicably connected with the at least one processor for storing instructions executable by the at least one processor, wherein execution of the instructions by the at least one processor causes the at least one processor to:

acquire a preview image;

abstract at least one parameter data of automatic exposure data, automatic white balance data and scene data of the preview image;

adjust the gamma parameter value according to the at least one parameter data of the automatic exposure data, the automatic white balance data and the scene data; and

adjust the current preview image according to the gamma parameter value.

In a third aspect, embodiments of the present application further provide a non-transitory computer-readable storage medium storing computer executable instructions that, when executed by an electronic device, cause the electronic device to:

acquire a preview image;

abstract at least one parameter data of automatic exposure data, automatic white balance data and scene data of the preview image;

adjust the gamma parameter value according to the at least one parameter data of the automatic exposure data, the automatic white balance data and the scene data; and

adjust the current preview image according to the gamma parameter value.

### BRIEF DESCRIPTION OF THE DRAWINGS

At least one embodiment is illustrated by way of example, and not by limitation, in the figures of the accompanying drawings, wherein elements having the same reference numeral designations represent like elements throughout. The drawings are not to scale, unless otherwise disclosed.

FIG. 1 is a schematic diagram of a method for dynamically adjusting gamma parameter according to some embodiments of this disclosure;

FIG. 2 is a schematic diagram of a method for dynamically adjusting gamma parameter according to according to some embodiments of this disclosure;

FIG. 3 is a schematic diagram of a method for dynamically adjusting gamma parameter according to according to some embodiments of this disclosure;

FIG. 4 is a schematic diagram of a method for dynamically adjusting gamma parameter according to according to some embodiments of this disclosure;

FIG. 5 is a structural representation of a device for dynamically adjusting gamma parameter according to some embodiments of this disclosure; and

FIG. 6 is a schematic diagram showing the hardware structure of an electronic device according to some embodiments of this disclosure.

### DETAILED DESCRIPTION

This disclosure will be illustrated in detail below in conjunction with the drawings and embodiments. It may be understood that, the embodiments described here are only used for explaining this disclosure, rather than limiting the scope of this disclosure. Additionally, it should be noted that, for easy description, the drawings only show the parts related to this disclosure, rather than the whole structure.

Before exemplary embodiments are discussed, it should be pointed out that, some exemplary embodiments are described as processes or methods depicted by flow charts. Although each operation (or step) is described as an ordered process in the flow chart, many operations therein may be implemented parallelly, concurrently or simultaneously. Moreover, the sequence of each operation may be rearranged. When the operation is completed, the process may be terminated; but the process may further have additional steps not included in the drawings. The process may correspond to a method, a function, a procedure, a subroutine and a subprogram, etc.

### Embodiment 1

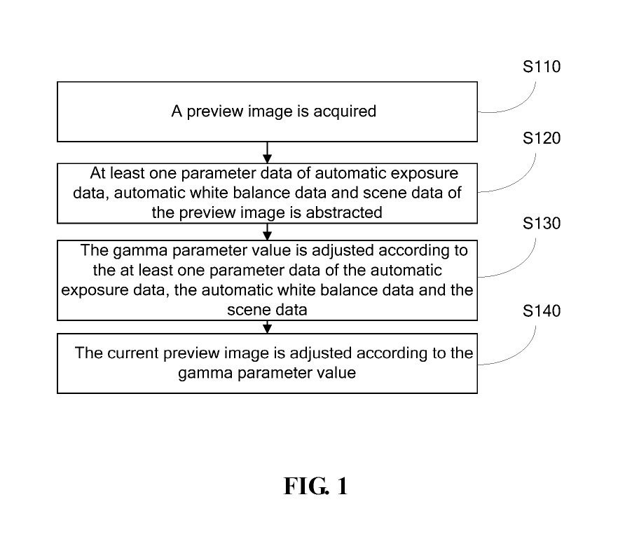

FIG. 1 is a schematic diagram of a method for dynamically adjusting gamma parameter according to Embodiment 1 of this disclosure. The method for dynamically adjusting gamma parameter is applied to an apparatus integrated with a photographing and/or filming function. Referring to FIG. 1, the method for dynamically adjusting gamma parameter includes Steps S110-S140:

In Step S110, a preview image is acquired.

After the apparatus with a photographing and/or filming function is turned on and before a photographing or filming action is completed, the image captured by an image sensor of the apparatus is referred to as a preview image. The preview image captured by the image sensor is acquired and stored in a buffer memory for being processed by a processor. Wherein, the apparatus with a photographing and/or filming function may be a mobile phone, a tablet computer, a personal notebook computer with a camera, a camera and a video camera.

In Step S120, at least one parameter data of automatic exposure data, automatic white balance data and scene data of the preview image is abstracted.

The automatic exposure parameter, the automatic white balance parameter and the scene data are all important parameters that influence the image quality. Exposure is a physical quantity used for calculating the luminous flux from a scene to a camera. The image sensor can obtain a high-quality photo only by obtaining the accurate exposure. Overexposure makes an image too bright, and underexposure makes an image too dim. The automatic exposure parameter may be controlled in accordance with the brightness value and the photographic sensitivity of a photo, where the preview image is divided into a plurality of subimages uniformly, and the brightness of each sub-image is used for setting a reference brightness value, which may be obtained by setting the shutter speed.

White balance is used for specifying the white or gray color of a scene for the apparatus with a photographing and/or filming function. With the designated numerical value of the white or gray color, the apparatus can calculate other colors based on this numerical value. The white colors under different light sources are different. In the prior art, the automatic white balance parameter is determined according to the statistical average of the color of each pixel point in the preview image.

Scene data are the brightness information in a brightness histogram. For example, when the brightness on the two ends of the brightness histogram is high and the brightness in the middle is low, the current scene will be a backlight scene.

In Step S130, the gamma parameter value is adjusted according to the at least one parameter data of the automatic exposure data, the automatic white balance data and the scene data.

After abstracting and analyzing at least one parameter data of the automatic exposure data, the automatic white balance data and the scene data of the preview image, the gamma parameter value may be adjusted according to any one parameter data thereof, and the gamma parameter value may also be adjusted according to two or three parameter data of the above parameters respectively. When the gamma parameter value is adjusted according to at least two of the above parameters, after the gamma parameter of each parameter data is adjusted, the adjusted gamma parameter value is corrected jointly according to weight of each parameter data.

In Step S140, the current preview image is adjusted according to the gamma parameter value;

The adjusted gamma parameter value is applied to adjust the current preview image, and the preview image acquired according to the adjusted gamma parameter value more approaches the nature of the scene. The real-time dynamic adjustment on the gamma parameter more approaches the perception of human eyes on the scene image.

In the technical solution according to the embodiment of this disclosure, the gamma parameter is adjusted according to at least one parameter data of automatic exposure data, automatic white balance data and scene data of a preview image, and the current preview image is adjusted according to the gamma parameter, thereby effectively recovering the nature of a scene, and improving the image quality.

### Embodiment 2

In the present embodiment, the adjusting the gamma parameter value according to the at least one parameter data of the automatic exposure data, the automatic white balance data and the scene data will be illustrated based on Embodiment 1.

In the present embodiment, the adjusting the gamma parameter value according to the at least one parameter data of the automatic exposure data, the automatic white balance data and the scene data includes: adjusting the current gamma parameter value as a fixed gamma parameter value corresponding to the independent segment data area when the automatic exposure data or the automatic white balance data are located within an independent segment data area corresponding to the parameter data; and obtaining an interpolation gamma parameter value corresponding to the automatic exposure data or the automatic white balance data by interpolating the endpoint value of the interpolation segment data area and a fixed gamma parameter value corresponding to the endpoint value, when the automatic exposure data or the automatic white balance data are located within an interpolation segment data area corresponding to the parameter data.

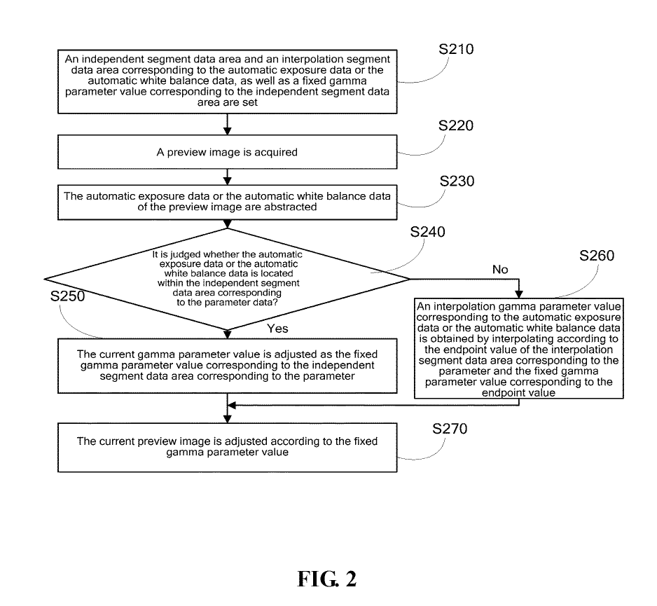

FIG. 2 is a schematic diagram of a method for dynamically adjusting gamma parameter according to according to Embodiment 2 of this disclosure. Referring to FIG. 2, the method for dynamically adjusting gamma parameter according to this embodiment includes Steps S210-S270:

In Step S210, an independent segment data area and an interpolation segment data area corresponding to the automatic exposure data or the automatic white balance data, and a fixed gamma parameter value corresponding to the independent segment data area are set.

In Step S220, a preview image is acquired.

In Step S230, the automatic exposure data or the automatic white balance data of the preview image are abstracted.

In Step S240, it is judged whether the automatic exposure data or the automatic white balance data is located within the independent segment data area corresponding to the parameter data; if the automatic exposure data or the automatic white balance data is located within the independent segment data area corresponding to the parameter, it turns to S250; if the automatic exposure data or the automatic white balance data is located outside the independent segment data area corresponding to the parameter, it turns to S260.

In Step S250, the current gamma parameter value is adjusted as the fixed gamma parameter value corresponding to the independent segment data area corresponding to the parameter, and it turns to S270.

Optionally, the automatic exposure parameter data may be brightness information lux_index, for example, the independent segment data area of the brightness information lux_index may include: lux_index≦170, 200≦lux_index≦370 and lux_index≧400.

Optionally, when the brightness information lux_index of the automatic exposure parameter data is located within the independent segment data area corresponding to the automatic exposure parameter, the corresponding gamma parameter value Gamma will be:

lux_index≦170, Gamma=gamma1;

200≦lux_index≦370, Gamma=gamma2;

lux_index≧400, Gamma=gamma3.

where, gamma1, gamma2 and gamma3 are fixed gamma parameter values.

In Step S260, an interpolation gamma parameter value corresponding to the automatic exposure data or the automatic white balance data is obtained by interpolating according to the endpoint value of the interpolation segment data area corresponding to the parameter and the fixed gamma parameter value corresponding to the endpoint value;

Exemplarily, in an example the automatic exposure parameter is the brightness information lux_index, the interpolation segment data area of the brightness information lux_index corresponding to the brightness information lux_index is: 170<lux_index<200, and 370<lux_index<400.

For example, when 170<lux_index<200, a linear or nonlinear interpolation is performed on the gamma parameter value gamma1 corresponding to the endpoint value 170 of the interpolation segment data area and the gamma parameter value gamma2 corresponding to the endpoint value 200 respectively, so that an interpolation gamma parameter value corresponding to the brightness information will be obtained.

In Step S270, the current preview image is adjusted according to the fixed gamma parameter value.

In the technical solution according to the embodiment of this disclosure, the gamma parameter is adjusted according to the automatic exposure data or the automatic white balance data of the preview image, and the current preview image is adjusted according to the gamma parameter, thereby effectively recovering the nature of a scene, and improving the image quality.

### Embodiment 3

In the present embodiment, the adjusting the gamma parameter value according to the at least one parameter data of the automatic exposure data, the automatic white balance data and the scene data will be further illustrated based on Embodiment 1. In the present embodiment, the adjusting the gamma parameter value according to the at least one parameter data of the automatic exposure data, the automatic white balance data and the scene data may include: selecting a gamma parameter value corresponding to the scene data area according to the scene data and the scene data area.

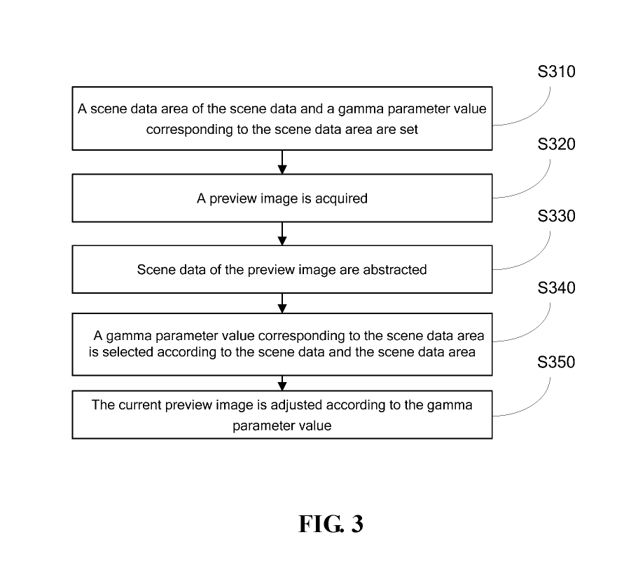

FIG. 3 is a schematic diagram of a method for dynamically adjusting gamma parameter according to according to Embodiment 3 of this disclosure. Referring to FIG. 3, the method for dynamically adjusting gamma parameter according to this embodiment includes Steps S310-S350:

In Step S310, a scene data area of the scene data and a gamma parameter value corresponding to the scene data area are set.

In Step S320, a preview image is acquired.

In Step S330, scene data of the preview image is abstracted.

In Step S340, a gamma parameter value corresponding to the scene data area is selected according to the scene data and the scene data area.

The scene is divided according to a gradient range of the scene data, i.e., the brightness information of the brightness histogram, where a respective scene corresponds to a certain gamma parameter value. Exemplarily, the scene is a backlight scene, and thus the gamma parameter value corresponding to the backlight scene is 1.5. Additionally, the scene may also include an outdoor scene and a dark scene. The gamma parameter values corresponding to different scenes may be set flexibly according to a practical situation.

In Step S350, the current preview image is adjusted according to the gamma parameter value.

In the technical solution according to the embodiment of this disclosure, the gamma parameter is adjusted according to the scene data of the preview image, and the current preview image is adjusted according to the gamma parameter, thereby effectively recovering the nature of a scene, and improving the image quality.

### Embodiment 4

In the present embodiment, the adjusting the gamma parameter value according to the at least one parameter data of the automatic exposure data, the automatic white balance data and the scene data will be illustrated based on the above embodiments. The method for dynamically adjusting gamma parameter according to this embodiment may include: adjusting the gamma parameter value according to at least two parameter data of the automatic exposure data, the automatic white balance data and the scene data respectively, and correcting the adjusted gamma parameter value according to the weight coefficients respectively corresponding to the at least two parameter data.

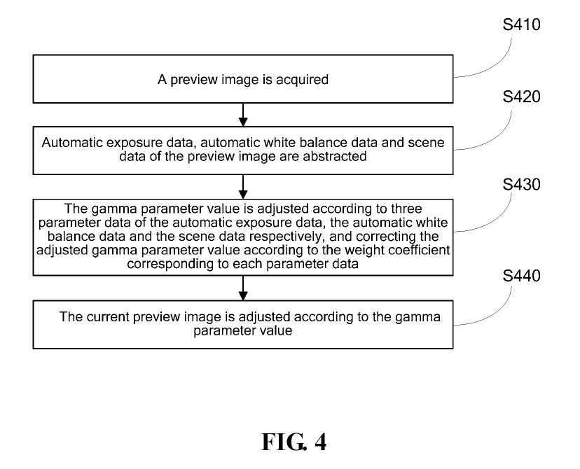

FIG. 4 is a schematic diagram of a method for dynamically adjusting gamma parameter according to according to Embodiment 4 of this disclosure. In the method for dynamically adjusting gamma parameter according to FIG. 4, the gamma parameter value is adjusted according to three parameter data of the automatic exposure data, the automatic white balance data and the scene data respectively, and the adjusted gamma parameter value is corrected according to the weight coefficient corresponding to each parameter data. Referring to FIG. 4, the method for dynamically adjusting gamma parameter according to this embodiment includes Steps S410-S440:

In Step S410, a preview image is acquired.

In Step S420, automatic exposure data, automatic white balance data and scene data of the preview image are abstracted;

In Step S430, the gamma parameter value is adjusted according to three parameter data of the automatic exposure data, the automatic white balance data and the scene data respectively, and the adjusted gamma parameter value is corrected according to the weight coefficient corresponding to each parameter data;

For example, the gamma parameter value is adjusted according to three parameter data of the automatic exposure data, the automatic white balance data and the scene data respectively, and the adjusted gamma parameter values are respectively 1.5, 1.2 and 1.8. The weight coefficients of the above three parameters are respectively 0.7, 0.2 and 0.1, and a corrected gamma parameter value is obtained by multiplying the adjusted gamma parameter value corresponding to each parameter respectively by the corresponding weight coefficient, that is, the corrected gamma parameter value Gamma=1.5×0.7+1.2×0.2+1.8×0.1=1.47.

The weight coefficient corresponding to each parameter may be set flexibly according to the image quality. The weight coefficient may be set by a developer via manual adjustment according to the image quality, or it may be set by a software algorithm via image quality judgement.

In Step S440, the current preview image is adjusted according to the gamma parameter value.

In the present embodiment, the gamma parameter value is adjusted according to three parameter data of the automatic exposure data, the automatic white balance data and the scene data, and the adjusted gamma parameter value is corrected according to the weight coefficient corresponding to each parameter. In the method for dynamically adjusting gamma parameter according to another implementation mode of this embodiment, the gamma parameter value may also be adjusted according to any two parameter data of the automatic exposure data, the automatic white balance data and the scene data, and the adjusted gamma parameter value may be corrected according to the weight coefficient corresponding to each parameter.

In the technical solution according to the embodiment of this disclosure, the gamma parameter is adjusted according to at least two parameter data of the automatic exposure data, the automatic white balance data and the scene data of the preview image, and the current preview image is adjusted according to the gamma parameter, thereby effectively recovering the nature of a scene, and improving the image quality.

### Embodiment 5

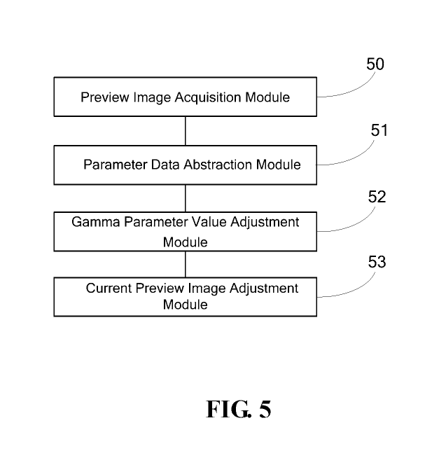

FIG. 5 is a structural representation of a device for dynamically adjusting gamma parameter according to Embodiment 5 of this disclosure. The device for dynamically adjusting gamma parameter is integrated in an apparatus with a photographing and/or filming function. The apparatus with a photographing and/or filming function may be a mobile phone, a tablet computer, a personal notebook computer with a camera, a camera and a video camera. Referring to FIG. 5, the device for dynamically adjusting gamma parameter includes: a preview image acquisition module 50, a parameter data abstraction module 51, a gamma parameter value adjustment module 52 and current preview image adjustment module 53.

The preview image acquisition module 50 is configured for acquiring a preview image;

The parameter data abstraction module 51 is configured for abstracting at least one parameter data of automatic exposure data, automatic white balance data and scene data of the preview image;

The gamma parameter value adjustment module 52 is configured for adjusting the gamma parameter value according to the at least one parameter data of the automatic exposure data, the automatic white balance data and the scene data; and

The current preview image adjustment module 53 is configured for adjusting the current preview image according to the gamma parameter value.

Optionally, the device for dynamically adjusting gamma parameter may also include a data setting module. The data setting module is configured for setting an independent segment data area and an interpolation segment data area corresponding to at least one parameter data of the automatic exposure data and the automatic white balance data, and a fixed gamma parameter value corresponding to the independent segment data area, and/or setting a scene data area corresponding to the scene data and a gamma parameter value corresponding to each scene data area.

Optionally, in the above device for dynamically adjusting gamma parameter, the gamma parameter value adjustment module 52 may include: a fixed gamma parameter value adjustment unit and an interpolation gamma parameter value adjustment unit.

The fixed gamma parameter value adjustment unit may be configured for adjusting the current gamma parameter value as the fixed gamma parameter value corresponding to the independent segment data area when the automatic exposure data or the automatic white balance data is located within an independent segment data area corresponding to the parameter data; and

The interpolation gamma parameter value adjustment unit may be configured for obtaining an interpolation gamma parameter value corresponding to the automatic exposure data or the automatic white balance data by interpolating according to an endpoint value of the interpolation segment data area and a fixed gamma parameter value corresponding to the endpoint value, when the automatic exposure data or the automatic white balance data is located within an interpolation segment data area corresponding to the parameter data.

Optionally, in the above device for dynamically adjusting gamma parameter, the gamma parameter value adjustment module 52 may also include a scene gamma parameter value adjustment unit.

The scene gamma parameter value adjustment unit may be configured for selecting a gamma parameter value corresponding to the scene data area according to the scene data and the scene data area.

Optionally, in the above device for dynamically adjusting gamma parameter, the gamma parameter value adjustment module 52 may include a gamma parameter value correction unit.

The gamma parameter value correction unit may be configured for adjusting the gamma parameter value according to at least two parameter data of the automatic exposure data, the automatic white balance data and the scene data, and correcting the adjusted gamma parameter value according to the weight coefficients corresponding to the at least two parameter data respectively.

The device for dynamically adjusting gamma parameter according to the present embodiment belongs to the same concept as that of the method for dynamically adjusting gamma parameter according to any embodiment of this disclosure, it may perform the method for dynamically adjusting gamma parameter according to any embodiment of this disclosure, and it has the corresponding functional modules and beneficial effects of the method for dynamically adjusting gamma parameter. For the technical details that are not described in detail in the present embodiment, the reference may be made to the method for dynamically adjusting gamma parameter according to any embodiment of this disclosure.

### Embodiment 6

In the embodiment of this disclosure, there provides a non-transitory computer-readable storage medium storing executable instructions that, when executed by an electronic device, cause the electronic device to perform the method according to the above embodiments.

### Embodiment 7

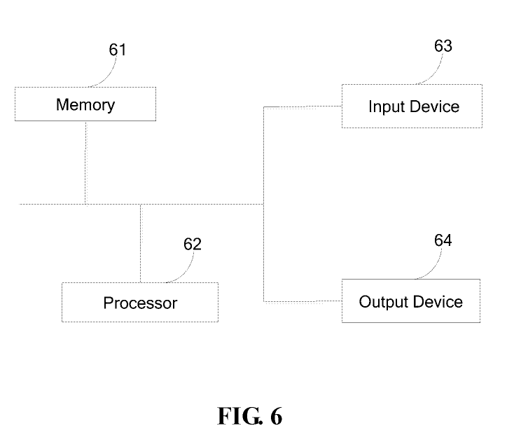

FIG. 6 is a schematic diagram showing the hardware structure of an electronic device according to Embodiment 7 of this disclosure; as shown in FIG. 6, the electronic device includes:

one or more processors 61, and a memory 62; FIG. 6 shows an example in which the mobile terminal includes one processor 61.

The electronic device may further include: an input device 63 and an output device 64.

The processor 61, the memory 62, the input device 63 and the output device 64 in the electronic device may be connected via a bus or in other modes. FIG. 6 shows an example in which they are connected via a bus.

As a nonvolatile computer-readable storage medium, the storage 62 may be configured for storing a software program, a computer-executable program and a module, for example, the program instruction/module corresponding to the method for dynamically adjusting gamma parameter according to the embodiments of this disclosure (for example, the preview image acquisition module 50, the parameter data abstraction module 51, the gamma parameter value adjustment module 52 and the current preview image adjustment module 53 shown in FIG. 5). The processor 61 executes the functional application and data processing of a server by running the software programs, instructions and modules stored on the storage 62, thereby realizing the method for dynamically adjusting gamma parameter according to the above method embodiments.

The memory 62 may include a program storage region and a data storage region, wherein, the program storage region may be configured for storing an operating system and at least one functional application program; and the data storage region may be configured for storing the data created according to the use of a terminal device, etc. Additionally, the memory 62 may include a high random access memory, or it may further include a nonvolatile memory, for example, at least one disk storage apparatus, flash memory apparatus or other nonvolatile solid-state memory apparatuses. In some examples, the memory 62 may optionally include a memory set remotely relative to the processor 61, such a remote memory may be connected to a terminal device via a network. Examples of the above network includes, but is not limited to, Internet, Intranet, Local Area Network (LAN), Mobile Communication Network and a combination thereof

The input device 63 may be configured for receiving digit or character information that is input and generating a key signal input related to the user setting and function control of the terminal. The output device 64 may include a display device, for example, a display screen, etc.

The one or more modules are stored on the memory 62. When executed by the one or more processors 61, the one or more modules will perform any method in the above embodiments.

The electronic equipment in embodiments of this application exists in various forms, including but not limited to:

(1) mobile telecommunication device. A device of this kind has a feature of mobile communicating function, and has a main object of providing voice and data communication. Devices of this kind include smart phone (such as iphone), multi-media cell phone, functional cell phone, low-end cell phone and the like;

(2) ultra mobile personal computer device. A device of this kind belongs to a category of personal computer, has functions of computing and processing, and generally has a feature of mobile internet access. Devices of this kind include PDA, MID, UMPC devices and the like, such as ipad;

(3) portable entertainment device. A device of this kind can display and play multi-media content. Devices of this kind include audio and video player (such as ipod), handheld game player, e-book, intelligent toy and portable vehicle navigation device;

(4) server, which is a device providing computing services. Construction of a server includes a processor, a hard disk, a memory, a system bus and the like. The server is similar to a common computer in architecture, but has high requirements in aspects of processing capacity, stability, reliability, security, expandability, manageability and the like since services of high reliability are needed to be provided;

(5) other electronic devices having data interacting functions.

Device embodiments described above are only illustrative, elements in the device embodiments illustrated as separated components may be or may not be physically separated, and components shown as elements may be or may not be physical elements, that is, the components may be located in one position, or may be distributed on a plurality of network units. Part or all of modules in the components may be selected according to actual requirements to achieve purpose of solutions in embodiments, which can be understood and perform by those of ordinary skill in the art without inventive works.

By descriptions of above embodiments, those skilled in the art can clearly learn that various embodiments can be achieved with aid of software and necessary common hardware platform, or with aid of hardware. Based on such an understanding, essential of above technical solutions or , in other words, parts of above technical solutions contributing to the related art may be embodied in form of software products which can be stored in a computer readable storage medium, such as a ROM/RAM, a disk, an optical disk and the like, and include a number of instructions configured to make a computer device (may be a personal computer, server, network device and the like) execute methods of various embodiments or parts of embodiments.

Finally, it should be noted that above embodiments are only used for illustrating but not to limit technical solutions of the present disclosure; although the present disclosure is described in detail with reference to the foregoing embodiments, those of ordinary skill in the art should understand that technical solutions recorded in the foregoing embodiments can be modified, or parts of the technical solutions can be equally replaced; and the modification and replacement dose not make essential of corresponding technical solutions depart from spirits and scope of technical solutions of various embodiments.

What is claimed is:

1. A method for dynamically adjusting gamma parameter, executed by an electronic device, the method comprising:
acquiring a preview image;
abstracting at least one parameter data of automatic exposure data, automatic white balance data and scene data of the preview image;
adjusting the gamma parameter value according to the at least one parameter data of the automatic exposure data, the automatic white balance data and the scene data; and
adjusting the current preview image according to the gamma parameter value.

2. The method according to claim 1, further comprising:
setting an independent segment data area and an interpolation segment data area corresponding to at least one parameter data of the automatic exposure data and the automatic white balance data, and a fixed gamma parameter value corresponding to the independent segment data area; and/or
setting a scene data area of the scene data and a gamma parameter value corresponding to each scene data area.

3. The method according to claim 2, wherein, the adjusting the gamma parameter value according to the at least one parameter data of the automatic exposure data, the automatic white balance data and the scene data comprises:
adjusting the current gamma parameter value as the fixed gamma parameter value corresponding to the independent segment data area corresponding to the parameter when the automatic exposure data or the automatic white balance data are located within the independent segment data area corresponding to the parameter; and
obtaining an interpolation gamma parameter value corresponding to the automatic exposure data or the automatic white balance data by interpolating according to an endpoint value of the interpolation segment data area corresponding to the parameter and a fixed gamma parameter value corresponding to the endpoint value, when the automatic exposure data or the automatic white balance data are located within the interpolation segment data area corresponding to the parameter.

4. The method according to claim 2, wherein, the adjusting the gamma parameter value according to the at least one parameter data of the automatic exposure data, the automatic white balance data and the scene data comprises:
selecting a gamma parameter value corresponding to the scene data area according to the scene data and the scene data area.

5. The method according to claim 1, wherein, the adjusting the gamma parameter value according to the at least one parameter data of the automatic exposure data, the automatic white balance data and the scene data comprises:
adjusting the gamma parameter value according to at least two parameter data of the automatic exposure data, the automatic white balance data and the scene data, respectively, and correcting the adjusted gamma parameter value according to the weight coefficients corresponding to the at least two parameters.

6. The method according to claim 2, wherein, the adjusting the gamma parameter value according to the at least one parameter data of the automatic exposure data, the automatic white balance data and the scene data comprises:
adjusting the gamma parameter value according to at least two parameter data of the automatic exposure data, the automatic white balance data and the scene data, respectively, and correcting the adjusted gamma parameter value according to the weight coefficients corresponding to the at least two parameters.

7. The method according to claim 3, wherein, the adjusting the gamma parameter value according to the at least one parameter data of the automatic exposure data, the automatic white balance data and the scene data comprises:
adjusting the gamma parameter value according to at least two parameter data of the automatic exposure data, the automatic white balance data and the scene data, respectively, and correcting the adjusted gamma parameter value according to the weight coefficients corresponding to the at least two parameters.

8. The method according to claim 4, wherein, the adjusting the gamma parameter value according to the at least one parameter data of the automatic exposure data, the automatic white balance data and the scene data comprises:
adjusting the gamma parameter value according to at least two parameter data of the automatic exposure data, the automatic white balance data and the scene data, respectively, and correcting the adjusted gamma parameter value according to the weight coefficients corresponding to the at least two parameters.

9. An electronic device for dynamically adjusting gamma parameter, comprising:
at least one processor; and
a memory communicably connected with the at least one processor for storing instructions executable by the at least one processor, wherein execution of the instructions by the at least one processor causes the at least one processor to:
acquire a preview image;
abstract at least one parameter data of automatic exposure data, automatic white balance data and scene data of the preview image;
adjust the gamma parameter value according to the at least one parameter data of the automatic exposure data, the automatic white balance data and the scene data; and
adjust the current preview image according to the gamma parameter value.

10. The electronic device according to claim 9, wherein the execution of the instructions by the at least one processor further causes the at least one processor to:
set an independent segment data area and an interpolation segment data area corresponding to at least one parameter data of the automatic exposure data and the automatic white balance data, and a fixed gamma parameter value corresponding to the independent segment data area; and/or
set the scene data area of the scene data and the gamma parameter value corresponding to each scene data area.

11. The electronic device according to claim 10, wherein, wherein the execution of the instructions by the at least one processor further causes the at least one processor to:
adjust the current gamma parameter value as the fixed gamma parameter value corresponding to the independent segment data area corresponding to the parameter when the automatic exposure data or the automatic white balance data are located within the independent segment data area corresponding to the parameter;
obtain an interpolation gamma parameter value corresponding to the automatic exposure data or the automatic white balance data by interpolating according to an endpoint value of the interpolation segment data area corresponding to the parameter and a fixed gamma parameter value corresponding to the endpoint value, when the automatic exposure data or the automatic white balance data are located within the interpolation segment data area corresponding to the parameter.

12. The electronic device according to claim 10, wherein the execution of the instructions by the at least one processor further causes the at least one processor to:
select a gamma parameter value corresponding to the scene data area according to the scene data and the scene data area.

13. The electronic device according to claim 9, wherein the execution of the instructions by the at least one processor further causes the at least one processor to:
adjust the gamma parameter value according to at least two parameter data of the automatic exposure data, the automatic white balance data and the scene data, respectively, and correct the adjusted gamma parameter value according to the weight coefficients corresponding to the at least two parameters.

14. The electronic device according to claim 10, wherein the execution of the instructions by the at least one processor further causes the at least one processor to:
adjust the gamma parameter value according to at least two parameter data of the automatic exposure data, the automatic white balance data and the scene data, respectively, and correct the adjusted gamma parameter value according to the weight coefficients corresponding to the at least two parameters.

15. The electronic device according to claim 11, wherein the execution of the instructions by the at least one processor further causes the at least one processor to:
adjust the gamma parameter value according to at least two parameter data of the automatic exposure data, the automatic white balance data and the scene data, respectively, and correct the adjusted gamma parameter value according to the weight coefficients corresponding to the at least two parameters.

16. The electronic device according to claim 12, wherein the execution of the instructions by the at least one processor further causes the at least one processor to:
adjust the gamma parameter value according to at least two parameter data of the automatic exposure data, the automatic white balance data and the scene data, respectively, and correct the adjusted gamma parameter value according to the weight coefficients corresponding to the at least two parameters.

17. A non-transitory computer-readable storage medium storing executable instructions that, when executed by an electronic device, cause the electronic device to:
acquire a preview image;
abstract at least one parameter data of automatic exposure data, automatic white balance data and scene data of the preview image;
adjust the gamma parameter value according to the at least one parameter data of the automatic exposure data, the automatic white balance data and the scene data; and
adjust the current preview image according to the gamma parameter value.
